(19) United States
(12) Patent Application Publication
(10) Pub. No.: US 2008/0175456 A1
(43) Pub. Date: Jul. 24, 2008

(54) METHODS FOR EXPLOSIVE DETECTION WITH MULTIRESOLUTION COMPUTED TOMOGRAPHY DATA

(76) Inventor: Dimitrios Ioannou, Fremont, CA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/624,349

(22) Filed: Jan. 18, 2007

(51) Int. Cl. G06K 9/00; G06K 9/40

(52) U.S. Cl. 382/131; 382/255

(57) ABSTRACT

Disclosed is an x-ray computed tomography inspection system having a computer processor configured to execute one or more specialized software-based image processing and/or detection methods. Among other features and benefits, the new methods create low-resolution SP images from low-resolution CT volumetric data, thus significantly improving throughput. An image processing and/or detection method segments and analyzes the generated SP images and decides whether the previously requested low resolution reconstructed CT image(s) are adequate, or whether additional higher resolution reconstructed CT images are needed.

### BACKGROUND

1. Field of the Invention

The present disclosure relates generally to inspection systems and, more particularly, to new methods for configuring a computerized inspection system to quickly detect alarm objects in scannable objects.

2. Discussion of Related Art

Computerized, radiation-based, inspection systems have been developed to detect explosives, contraband, and other types of alarm objects in scannable objects such as pieces of baggage, clothing, shoes, and the like.

Two types of inspection systems are used for computed tomography (“CT”)-based detection of explosives. One type of inspection system manufactured by GE Homeland Protection, Inc., (formerly InVision, Inc.) of Newark, Calif., which is a subsidiary of the General Electric Company, uses dedicated hardware in the form of a scan projection (SP) unit to generate a scan projection image. Comprising single-angle (e.g., two-dimensional) projections of a scanned object, scan projection images are similar to the more familiar x-ray images. Scan projection images provide only limited information about the characteristics of a scanned object because the projection data is restricted to a single-angle. Based on information provided by the SP image, a CT scanner can make intelligent decisions about what area or areas of the scanned object should receive CT slices. A CT slice is a two-dimensional, planar segment of the scanned object, which has a unique density of x-rays that varies depending on how much attenuation the contents of the scanned object afford. Using a combination of the information provided by the SP unit and the CT scanner, a specialized software-based detection algorithm associated with the inspection system then estimates the mass and density of the contents of the scanned object. The estimated mass and density values are then compared against known characteristics of explosives, illegal drugs, and other contraband. If a match is found, the inspection system notifies the system operator, optionally highlights the area(s) of concern in both SP and CT images, and/or provides images of the potential threat for further analysis.

A second type of inspection system, manufactured by International Security Systems Corporation, which is a subsidiary of Analogic Corporation, uses full volumetric descriptions of the contents of a scanned object. Such full volumetric descriptions render use of an SP image to estimate densities and masses unnecessary, but are relatively time-consuming and computationally expensive to obtain.

What is still needed are new methods for configuring a security inspection system to detect explosives, drugs, and other contraband in a piece of baggage more quickly than the prior art inspection systems and methods described above.

### BRIEF DESCRIPTION

The present disclosure describes new methods for configuring an inspection system to quickly detect alarm objects in a scannable object. In a security application, non-limiting examples of alarm objects may include explosives, drugs, and other contraband.

For ease of description, embodiments of the new methods are described below in the non-limiting context of a security application, where an inspection system is configured to detect explosives more quickly than prior generations of explosive detection systems. It is intended, however, that the scope of the appended claims include other types of applications (such as medical applications, engineering applications, etc.) and other types of alarm objects (such as tumors, cysts, product components, etc.).

In an embodiment, the inspection system is an x-ray computed tomography scanner having a computer processor configured to execute one or more specialized software-based image processing and/or detection methods. Among other features and benefits, the new methods create two-dimensional, low-resolution SP images from low-resolution CT volumetric data (“CT volume”) of a scannable object, thus significantly improving throughput. In particular, embodiments of the new method significantly decrease scan times by producing one or more SP images without using a separate scan projection unit, as conventionally required. In a non-limiting embodiment, producing low-resolution SP images directly from the raw CT volumetric data decreases the time needed to scan an object by at least a factor of four (4). Additionally, a software-based detection image processing and/or detection method segments and analyzes the generated SP images and decides whether the previously requested low resolution reconstructed CT image(s) are adequate, or whether additional higher resolution reconstructed CT images are needed.

In an embodiment, a method includes reconstructing a low-resolution computed tomography (“CT”) volume from raw volumetric CT data (“CT volume”) representative of a scannable object. The method further includes obtaining a two-dimensional, low-resolution scan projection (SP) image from the low-resolution CT volume. The SP image may include one or more SP regions. Additionally, the method includes determining whether a high-resolution CT image of only one or more portions of the scannable object that correspond to the one or more SP regions is needed.

In another embodiment, a method includes obtaining raw volumetric CT data from a scan of a scannable object; reconstructing the raw volumetric CT data; obtaining a low-resolution CT volume; and performing a scan projection (SP) re-projection of the low-resolution CT volume.

Other features and advantages of the disclosure will become apparent by reference to the following description taken in connection with the accompanying drawings.

### BRIEF DESCRIPTION OF THE DRAWINGS

FIG. 1 is a flowchart depicting an embodiment of a new method for configuring an inspection system to quickly detect one or more alarm objects;

FIG. 2 is another flowchart depicting another embodiment of another new method for configuring an inspection system to quickly detect one or more alarm objects;

FIG. 3 is a perspective view of an x-ray CT scanner configured to perform the new methods of FIGS. 1 and 2; and

FIG. 4 is a schematic diagram of components that may be included in the x-ray CT scanner of FIG. 3.

Like reference characters designate identical or corresponding components and units throughout the several views.

### DETAILED DESCRIPTION

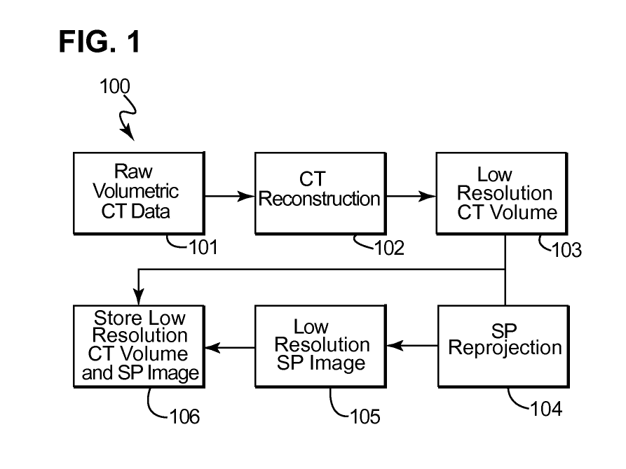

FIG. 1 is a flow chart illustrating a first embodiment of a new method 100 for configuring an airport security inspection system, or other type of inspection system, to detect an alarm object in a scannable object. The term “alarm object” refers to any substance or thing that an inspection system is configured to detect. As noted above, non-limiting examples of alarm objects include explosives, illegal drugs, and hazardous substances, among others. Non-limiting examples of explosives include nitroglycerin, nitrocellulose, nitroguandidine, cyclotrimethylenetrinitramine (“RDX”), and trinitrotoluene (“TNT”), among others.

In an embodiment, the term “high-resolution” refers to resolutions greater than 256×256 and/or greater than 256×256×L, where L is the length of the bag in pixels. Similarly, the term “low-resolution” refers to resolutions equal to or less than 256×256 and/or less than 256×256×L. It will be appreciated that other resolutions may be used in the methods described herein to further improve an inspection system's computational speed. It will further be appreciated that the term “low-resolution” may also refer to a multi-dimensional resolution that is less (in at least one dimension) than a corresponding multi-dimensional “high-resolution”—preferably at least two times less. For example, if a high-resolution of 1024×1024 is used, a low-resolution would include any of: 1023×1023, 512×512, and 256×256, among others. Illustratively, a CT scan using a low-resolution 256×256 reconstruction improves computational speed by a factor of four (4) over a CT scan using a high-resolution 512×512 reconstruction.

An embodiment of the method 100 enables the fast creation of two-dimensional low-resolution scan projection (SP) images using only raw volumetric data provided by an x-ray computed tomography (CT) scanner. Preferably, this is accomplished without the use of a separate scan projection unit. Advantages associated with eliminating the need to use a separate scan projection unit include not only a significant reduction in the time required to detect, analyze, and identify alarm objects, but also a reduction in the cost of manufacturing an inspection system.

Referring to FIG. 1, an embodiment of the method may include a step 101 of obtaining raw volumetric CT data representative of a scannable object. Such data may be obtained by scanning the scannable object using an x-ray CT scanner.

The method 100 may further include a step 102 of reconstructing at a low-resolution the raw volumetric CT data, and a resultant step 103 of obtaining (from the reconstruction) a low-resolution CT volume, which corresponds to the volume of the whole scannable object (“CT volume”). The computerized reconstruction may use any known image reconstruction technique. The method 100 may further include a step 104 of generating a scan projection (SP) re-projection, and another resultant step 105 of obtaining (from the re-projection) a low-resolution SP image. The computerized SP re-projection can be performed using any known re-projection technique. The method 100 may further include a step 106 of storing (in a memory element) either or both of the low-resolution CT volume generated in steps 102, 103 and the low-resolution SP image generated in steps 104, 105.

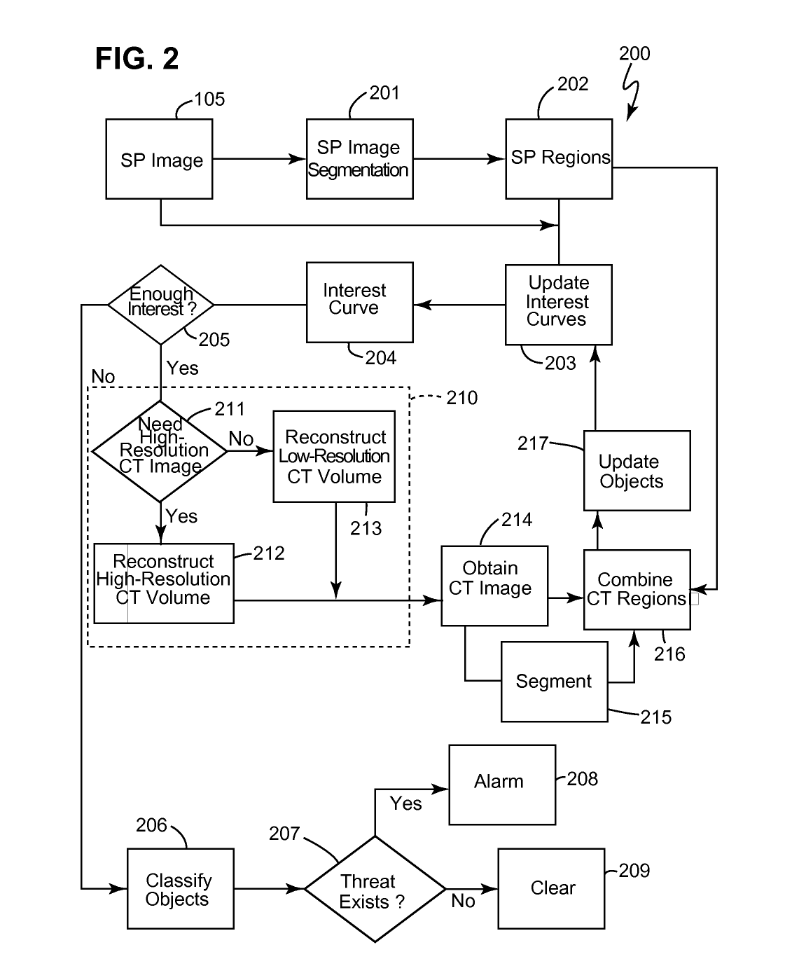

FIG. 2 is another flowchart of an embodiment of another new method 200 for improving computational speeds in computerized inspection systems. The method 200 may include or begin at step 105 of the method 100 previously described above. The step 105 may comprise obtaining a low-resolution scan projection (SP) image that a computer derives by SP re-projecting an already reconstructed low-resolution CT volume. The method 200 may further include a step 201 of segmenting the SP image, and a resultant step 202 of obtaining one or more SP regions. Either or both of the SP image and the one or more SP regions may be used, at a step 203 of updating an interest curve. In an embodiment, an interest curve is a line (or a portion thereof) that connects one or more data points plotted against a first axis representative of an independent variable (often the horizontal axis, commonly labeled the “x-axis”) and an orthogonal second axis representative of a dependent variable (often the vertical axis, commonly labeled the “y-axis”). One embodiment of an interest curve involves setting the x-axis to represent different SP regions of the segmented SP image, and setting the y-axis to represent measured density or mass. Each data point plotted on the graph represents a specific measured density or mass for each SP region, and the line connecting the data points can be analyzed to determine whether a predetermined threshold mass or density value is exceeded. Additionally, the one or more SP regions from step 202 may be used at step 217 (further described below) to update threat information about the scannable object and/or other objects contained therein.

The method 200 may further include a step 204 of obtaining an interest curve. The method 200 may further include a step 205 of evaluating the interest curve to determine if a predetermined threshold has been exceeded in a predetermined number of SP regions. If not, the method 200 proceeds to a step 206 of classifying and identifying the alarm object(s) using the low-resolution SP image and/or the low-resolution CT volume, and thereafter to a step 207 of determining whether a threat exists. The step 207 of determining whether a threat exists may include a sub-step of comparing a density and/or mass of a scannable object or one of its contents with known density/mass tables for various predetermined alarm objects. If a threat exists, the method 200 may proceed to a step 208 of indicating an alarm to an operator of the inspection system. The alarm may be visible (e.g., flashing light, highlighted area of a displayed image of the scanned object, etc.) and/or audible. If no threat exists, the method 200 may proceed to a step 209 of clearing the scannable object.

As mentioned above, the step 205 includes evaluating the interest curve to determine if a predetermined threshold has been exceeded in a predetermined number of SP regions. If the threshold has been met or exceeded, the one or more SP regions in which the threshold is met or exceed are classified as “suspect SP region(s).” The method 200 then proceeds to block 210, which includes three method steps 211, 212, and 213. Method step 211 comprises determining whether one or more high-resolution CT images are required of one or more suspect SP regions. If so, reconstruction of the previously obtained raw volumetric CT data (“CT volume”) occurs at step 212. As used herein, “CT image” refers to a subvolume (e.g., “CT slice”) of the CT volume that corresponds to an SP region. The result of step 212 is the obtaining (step 214) of one or more high-resolution CT image(s) that correspond to one or more SP regions. As mentioned above, the high-resolution CT image is reconstructed using the original raw CT volumetric data. Although the resolution is higher, the computational time is minimal because only a portion of the entire scannable object is subjected to the high-resolution reconstruction. At step 215, the high-resolution image is segmented into a small number of discrete CT regions that correspond to the “suspect” SP regions. Using the SP region information combined with the characteristics of the CT regions and the use of interpolation, the inspection system can approximate several critical characteristics, such as mass and density, of the scannable object(s).

At step 216, the regions from the segmented CT images are combined. The method 200 may further include an optional step (not shown) of combining a CT region (alarm object) with a SP region. This can be achieved, in one embodiment, by reprojecting the scannable object and finding a corresponding SP region. Thereafter, the method 200 may proceed to a step 217 of updating threat information about the scannable object and/or objects contained therein. The threat information may be obtained by analyzing one or more (low or high resolution) CT images. Additionally, the threat information may include a mass and/or density of one or more previously defined alarm objects. Once the threat information has been updated, the method 200 may proceed to the previously described step 203 of updating interest curves.

Referring again to step 211, if a high-resolution CT image is not required, the method 200 may proceed to a step 213 of obtaining a low-resolution CT image. (If method 200 is used together with method 100, this low-resolution CT image will have been stored at step 106.) Thereafter, the method 200 may proceed to a resultant step 214 of obtaining a (segmented, low-resolution CT image). In such an embodiment, the SP image may have an equivalent low-resolution as the high-resolution CT volume. Illustratively, the term “equivalent low-resolution” refers to a two-dimensional SP image resolution that is the same as at least one dimension of a corresponding low-resolution CT volume from which the SP image is re-projected. Illustratively, if the CT volume has a low-resolution of 256×256×L, the obtained two-dimensional SP image will have a low-resolution of 256×L. Thereafter, the method 200 may proceed to the steps 216, 217, and 203 as described above.

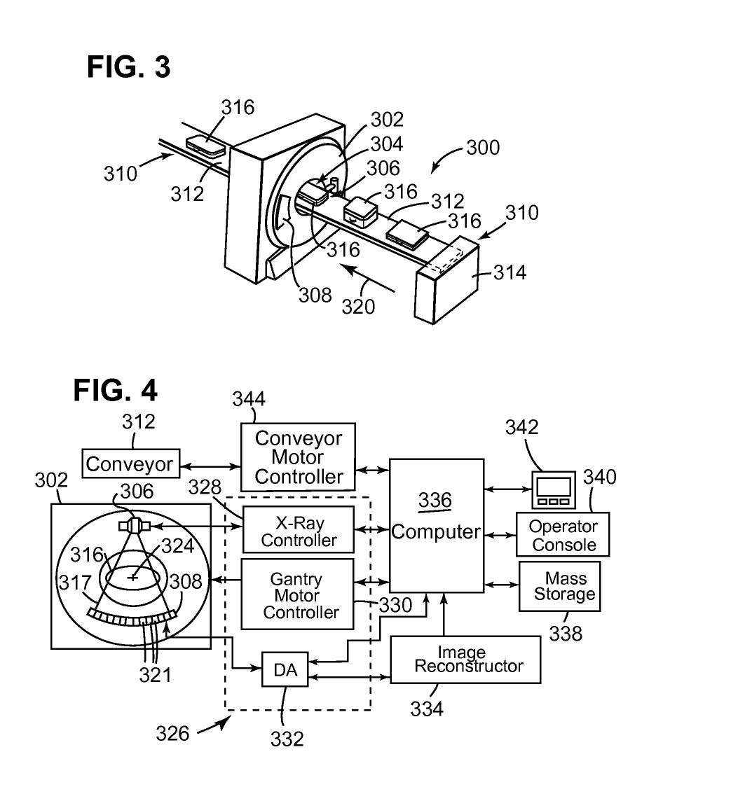

Referring now to FIG. 3, an inspection system 300 configured according to an embodiment of the invention includes a CT scanner 303 having a rotatable gantry 302. In FIG. 3, the shielding curtains and the housing of the inspection system have been omitted to more clearly show the scanning and conveyor components of the inspection system 300. The rotatable gantry 302 has an opening 304 therein, through which packages or bags 316 may pass.

The rotatable gantry 302 houses an x-ray source 306 as well as a detector assembly 308 having scintillator arrays comprised of scintillator cells. A conveyor system 310 is also provided. The conveyor system 310 includes a conveyor belt 312 supported by structure 314 to automatically and continuously pass packages or bags 316 through opening 304 to be scanned. Directional arrow 320 indicates the direction in which the conveyor belt 312 rotates. Objects 316 are fed through opening 304 by conveyor belt 312. Imaging data is then acquired, and the conveyor belt 312 removes the packages 316 from the gantry opening 304 in a controlled and continuous manner. As a result, inspectors, baggage handlers, and other security personnel may non-invasively inspect the contents of packages 316 for alarm objects. Additional aspects of the inspection system 300 are described below with reference to FIGS. 3 and 4.

FIG. 4 is a block schematic diagram of a scanner that may be used in an inspection system configured according to an embodiment of the invention. Referring to FIGS. 3 and 4 together, the inspection system 300 may be an explosive detection system that includes an x-ray CT scanner. As used herein, “explosive detection system” refers to a particular category of inspection system, configured to detect explosives in baggage. Referring again to FIGS. 3 and 4, the x-ray CT scanner includes a circular, movable gantry 302. An x-ray source 306 attached to the gantry 302 projects a fan beam of x-rays 317 across the interior of the gantry 302 to a detector array 308 that is also attached to the gantry 302. The detector array 308 is formed by a plurality of detector modules 321, which together sense the projected x-rays that pass through an object 316. Each detector module 321 comprises an array of pixel elements (pixels). Each pixel comprises in part a photosensitive element, such as a photodiode, and one or more charge storage devices, such as capacitors. Each pixel produces an electrical signal that represents the intensity of an impinging x-ray beam and hence the attenuated beam as it passes through the object 316. During a scan to acquire x-ray projection data, gantry 302 and the components mounted thereon rotate about a center of rotation 324.

Rotation of gantry 302 and the operation of x-ray source 306 are governed by a control mechanism 326 of the inspection system 300. Control mechanism 326 includes an x-ray controller 328 that provides power and timing signals to an x-ray source 306 and a gantry motor controller 330 that controls the rotational speed and position of gantry 302. A data acquisition system (DAS) 332 in control mechanism 326 samples analog data from detectors 321 and converts the data to digital signals for subsequent processing. An image re-constructor 334 receives sampled and digitized x-ray data from DAS 332 and performs high-speed reconstruction. The reconstructed image is applied as an input to a computer 336, which stores the image in a mass storage device 538.

Computer 336 also receives commands and scanning parameters from an operator via console 340 that has a keyboard. An associated display 342 allows the operator to observe the reconstructed image and other data from computer 336. The operator supplied commands and parameters that are used by computer 336 to provide control signals and information to DAS 332, x-ray controller 328, and gantry motor controller 330. In addition, computer 336 operates a conveyor motor controller 344, which controls a conveyor belt 312 to position object 316 within the gantry 302. Particularly, conveyor belt 312 moves portions of the object 316 through the gantry opening 304.

The methods illustrated in FIGS. 1 and 2, and/or their equivalents, can be implemented in a microprocessor and associated memory elements within an inspection system, such as the one illustratively depicted in FIGS. 3 and 4. Accordingly, the method steps shown in FIGS. 1 and 2 represent computer-executable program code stored in the memory elements and operable in the microprocessor. When implemented in the microprocessor, the program code configures the microprocessor to create logical and arithmetic operations to process the flow chart steps, and/or their equivalents.

The methods of FIGS. 1 and 2, and/or their equivalents, may also be embodied in the form of computer program code written in any of the known computer languages containing instructions embodied in tangible media such as floppy diskettes, CD-ROM's, hard drives, DVD's, removable media or any other computer-readable storage medium. When the program code is loaded into and executed by a general purpose or a special purpose computer, the computer becomes an apparatus for practicing the new methods described herein, and/or their equivalents.

The methods of FIGS. 1 and 2, and/or their equivalents, can also be embodied in the form of a computer program code, for example, whether stored in a storage medium loaded into and/or executed by a computer or transmitted over a transmission medium, such as over electrical wiring or cabling, through fiber optics, or via electromagnetic radiation, wherein when the computer program code is loaded into and executed by a computer, the computer becomes an apparatus for practicing the new methods described herein, and/or their equivalents.

The embodiments of the new methods described herein illustrative only. Although only a few embodiments of the invention have been described in detail in this disclosure, those skilled in the art who review this disclosure will readily appreciate that many modifications are possible without materially departing from the novel teachings and advantages of the subject matter recited in the appended claims.

Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the embodiments of the invention as expressed in the appended claims.

What is claimed is:

1. A method, comprising:
reconstructing a low-resolution computed tomography (“CT”) volume from raw volumetric CT data representative of a scannable object;
obtaining a two-dimensional, low-resolution scan projection (SP) image from the low-resolution CT volume, wherein the SP image includes an SP region; and
determining whether a high-resolution CT image of only a portion of the scannable object that corresponds to the SP region is needed.

2. The method of claim 1, further comprising:
requesting the high-resolution CT image.

3. The method of claim 2, further comprising:
analyzing the high-resolution CT image to obtain new threat information about the scannable object; and
updating prior threat information about the scannable object with the new threat information.

4. The method of claim 3, further comprising:
creating an interest curve based on the updated prior threat information.

5. The method of claim 2, further comprising:
segmenting the high-resolution CT image into a CT region, wherein the CT region corresponds to the SP region.

6. The method of claim 5, further comprising:
combining the CT region with the SP region.

7. The method of claim 1, further comprising:
requesting a low-resolution CT image.

8. The method of claim 7, further comprising:
analyzing the low-resolution CT image to obtain new threat information about the scannable object; and
updating prior threat information about the scannable object with the new threat information.

9. The method of claim 8, further comprising:
creating an interest curve based on the updated prior threat information.

10. The method of claim 7, further comprising:
segmenting the low-resolution CT image into a CT region, wherein the CT region corresponds to the SP region.

11. A method, comprising:
obtaining raw volumetric CT data from a scan of a scannable object;
obtaining a low-resolution CT volume from reconstruction of the raw volumetric CT data; and
obtaining a scan projection (SP) image from re-projection of the low-resolution CT volume.

12. The method of claim 11, further comprising:
storing the low-resolution CT volume and the SP image.
